(19) United States
(12) Patent Application Publication
(10) Pub. No.: US 2026/0319750 A1
(43) Pub. Date: Oct. 15, 2026

(54) RANDOM NUMBER GENERATION DEVICE FOR GENERATING TRUE RANDOM NUMBER AND CRYPTO SYSTEM INCLUDING THE SAME

(71) Applicant: Samsung Electronics Co., Ltd., Suwon-si (KR)

(72) Inventors: Sangsig Kim, Seoul (KR); Kyoungah Cho, Seoul (KR); Hyojoo Heo, Seoul (KR); Taeho Park, Seoul (KR); Yunwoo Shin, Seoul (KR)

(73) Assignee: Korea University Research And Business Foundation, Seoul (KR)

(21) Appl. No.: 19/563,022

(22) Filed: Mar. 11, 2026

(30) Foreign Application Priority Data
Apr. 10, 2025 (KR) 10-2025-0046980

(51) Int. Cl. G06F 7/58; H04L 9/08

(52) U.S. Cl. CPC G06F 7/588; H04L 9/0869

(57) ABSTRACT

A random number generation device includes at least one true random number generator, and the at least one true random number generator includes a gated diode including first and second gate regions disposed on an intrinsic region and doped with different dopants and first and second gate electrodes respectively stacked on the first and second gate regions and a resistor connected in series to the gated diode. A crypto system includes the random number generation device.

### CROSS-REFERENCE TO RELATED APPLICATION

This application is based on and claims priority under 35 U.S.C. §119 to Korean Patent Application No. 10-2025-0046980, filed on Apr. 10, 2025, in the Korean Intellectual Property Office, the disclosure of which is incorporated by reference herein in its entirety.

### TECHNICAL FIELD

The disclosure relates to an electronic device, and more particularly, to a random number generation device for generating a true random number and a crypto system including the same.

### BACKGROUND

Along with the development of Internet of Things (IoT) according to the fourth industrial revolution, electronic devices may share information over a network, thereby changing a communication environment to a hyper-connected society. Although information may be shared across various fields with the popularization of IoT, situations frequently arise in which information is misused by an unauthorized user. Accordingly, the significance of security technology, such as data encryption and device authority authentication, has increased.

Data encryption is a technique of obfuscating data by using various kinds of security information, such as a generator security key and an authentication key, such that an unauthorized user cannot misuse the data. A random number generator for the technique may generate an unpredictable random number without any regularity or periodicity. The random number generator may include a pseudo random number generator based on software and a true random number generator based on hardware.

The pseudo random number generator calculates a random number by using a given seed and a polynomial. A method of implementing the pseudo random number generator is simple but uses a lot of resources and has a problem in that a non-authorized user may identify the random number generation pattern of the pseudo random number generator by using advanced hacking skills. That is, the advanced hacking skills may be used to predict a random number to be generated thereafter based on a previously generated random number column. Therefore, there is a demand for a true random number generator for fundamentally preventing hacking.

Recently, research has been conducted to implement a true random number generator by using physical noise, such as thermal noise, shot noise, and burst noise, of a complementary metal-oxide-semiconductor (CMOS) circuit. However, such a true random number generator consumes much energy and is difficult to miniaturize.

However, to efficiently encrypt rapidly increasing data, the development of a multinary (binary or above) true random number generator is necessary. Research has been conducted to implement a ternary true random number generator using randomness of an oxide resistance change material, such as tantalum oxide (TaOₓ) or hafnium oxide (HfOₓ), and a non-silicon material, such as a ferromagnetic body, but such a ternary true random number generator is vulnerable to a temperature and uses a spin-orbit torque device that is difficult to produce. Therefore, devices constituting a multinary true random number generator require thermally stable electrical characteristics and high manufacturing uniformity. Accordingly, a multinary true random number generator including devices having reliable electrical characteristics, obtained by an existing CMOS process technique, and high manufacturing uniformity is required.

### SUMMARY

The disclosure provides a true random number generator, a random number generation device, and a crypto system for generating a true random number that cannot be fundamentally hacked.

The disclosure also provides a true random number generator, a random number generation device, and a crypto system, which consume relatively little energy and are miniaturized.

The disclosure also provides a true random number generator, a random number generation device, and a crypto system, which can be obtained by a complementary metal-oxide-semiconductor (CMOS) technique and have thermally stable electrical characteristics and high manufacturing uniformity.

According to an aspect of the disclosure, there is provided a random number generation device including at least one true random number generator, the at least one true random number generator including a gated diode including a first region, a second region, an intrinsic region between the first region and the second region, a first gate region disposed on the intrinsic region and doped with a first dopant, a first gate electrode disposed on the first gate region, a second gate region disposed on the intrinsic region, arranged side by side with the first gate region, and doped with a second dopant having characteristics different from those of the first dopant, and a second gate electrode disposed on the second gate region and a resistor electrically connected in series to the gated diode.

According to another aspect of the disclosure, there is provided a random number generation device including a pulse generator configured to generate a pulse signal having a voltage level during an on period, a voltage source circuit configured to provide each of a plurality of gate voltages, and at least one true random number generator configured to generate a random number based on the pulse signal and the plurality of gate voltages. The at least one true random number generator includes a gated diode including an anode electrode that receives the pulse signal, a first gate electrode to which any one gate voltage among the plurality of gate voltages is applied, a second gate electrode to which another gate voltage among the plurality of gate voltages is applied, and a cathode electrode and a resistor including one terminal electrically connected to the cathode electrode and the other terminal electrically connected to an output node that outputs an output current having a current value corresponding to the random number.

According to another aspect of the disclosure, there is provided a crypto system including a random number generation device configured to generate key data including a plurality of random numbers constituting a security key and an encryption device configured to generate encrypted image data, based on the key data and image data including a plurality of pixel values constituting an image. The random number generation device includes a pulse generator configured to generate a pulse signal having a voltage level during an on period, a voltage source circuit configured to provide each of a plurality of gate voltages, and a plurality of true random number generators configured to output an output current having a current value corresponding to a multinary random number for the pulse signal based on the pulse signal and the plurality of gate voltages.

### BRIEF DESCRIPTION OF THE DRAWINGS

Embodiments of the disclosure will be more clearly understood from the following detailed description taken in conjunction with the accompanying drawings in which:

FIGS. 1A - 1I illustrate a true random number generator of a random number generation device according to some embodiments;

FIGS. 2A and 2B illustrate a binary random number generation device according to some embodiments;

FIGS. 3A and 3B illustrate a binary random number generation device according to some embodiments;

FIGS. 4A - 4D illustrate a quaternary random number generation device according to some embodiments;

FIGS. 5A, 5B, and 5C illustrate a quaternary random number generation device according to some embodiments;

FIG. 6 illustrates a multinary random number generation device according to some embodiments;

FIG. 7 is a block diagram of a crypto system according to some embodiments; and

FIG. 8 illustrates an image, a security key, and an encrypted image according to some embodiments.

### DETAILED DESCRIPTION OF THE EMBODIMENTS

Hereinafter, embodiments are described in detail with reference to the accompanying drawings.

The ordinal expressions, such as "first", "second", "third", and "fourth", used in the specification may modify various components regardless of a sequence and/or significance and are only used to distinguish one component from other components without limiting the components. For example, a first user device and a second user device may indicate different user devices regardless of a sequence or significance. For example, without departing from the right scope described in the specification, a first component may be named a second component, and similarly, the second component may also be named the first component. First components in the specification may be named a first component, a second component, a third component, a fourth component, a fifth component, a sixth component, and the like, and second components in the specification may be named a first component, a second component, a third component, and the like.

In the specification, "image" is visual information including a plurality of pixels. "Image data" is data including the pixel values of a plurality of pixels of an image. "Pixel value" is a gray scale represented by brightness of 256 levels in decimal, and 0 to 255 in decimal may be represented as binary numbers, quaternary numbers, hexadecimal numbers, base 256 numbers, or the like. For example, 82 in decimal is 1010010 in binary of the binary system, 1102 in quaternary, and 52 in hexadecimal. For example, 108 in decimal is 1101100, 1230, 6C in binary, quaternary, and hexadecimal, respectively.

In the specification, "security key" is security information used to encrypt an image or information used to decrypt an encrypted image. "Key data" is data including a plurality of random numbers constituting a security key. The total number of random numbers constituting a security key may be a number obtained by multiplying the number of digits for indicating the pixel value of one pixel as a base n number by the total number of pixels of an image. Herein, n may be an integer greater than or equal to 2, for example, any one of 2, 4, 16, and 256. In this case, because the gray scale is represented by 256 levels, the number of digits for indicating a pixel value in binary is 8, the number of digits for indicating a pixel value in quaternary is 4, the number of digits for indicating a pixel value in hexadecimal is 2, and the number of digits for indicating a pixel value in base-256 is 1.

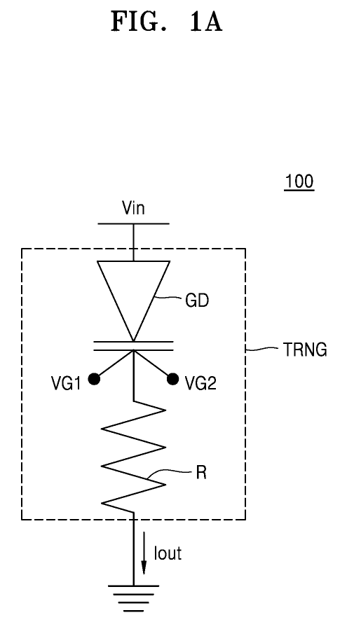

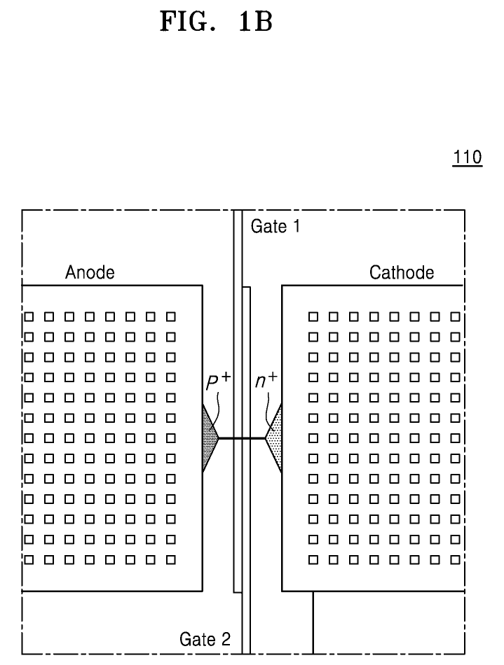

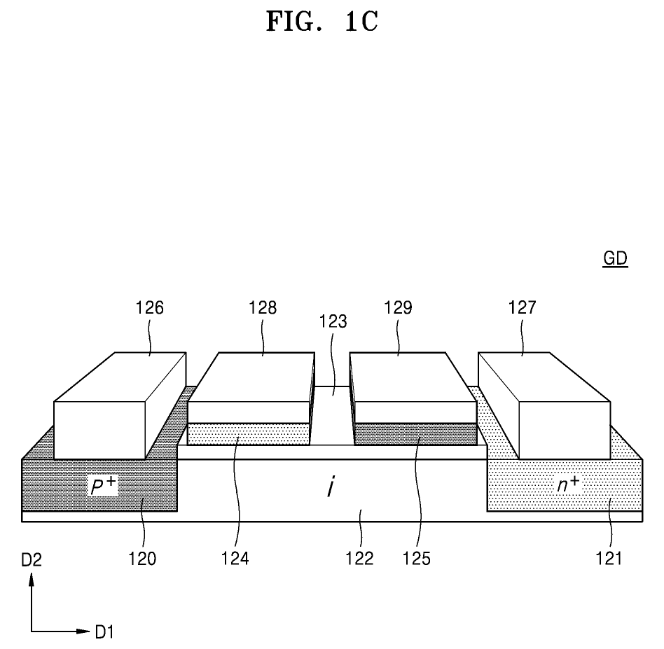

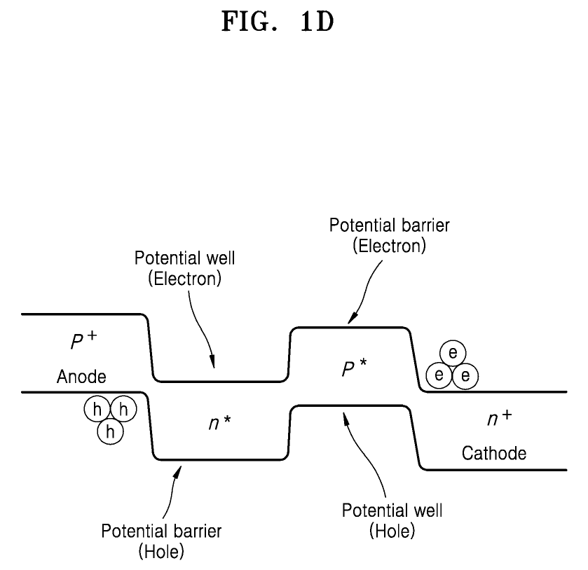

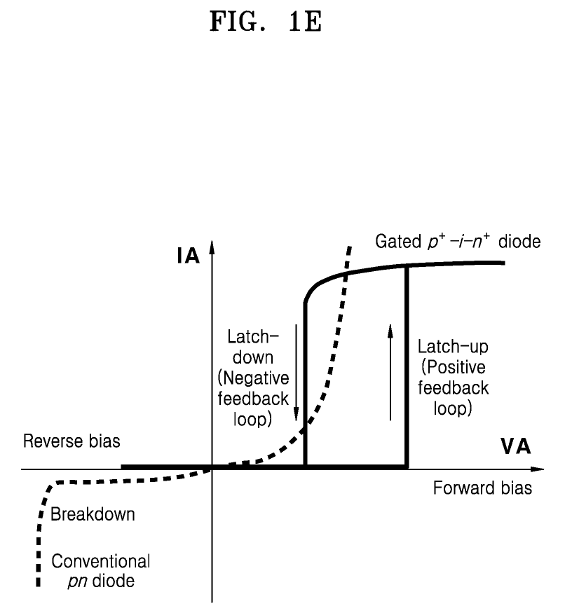

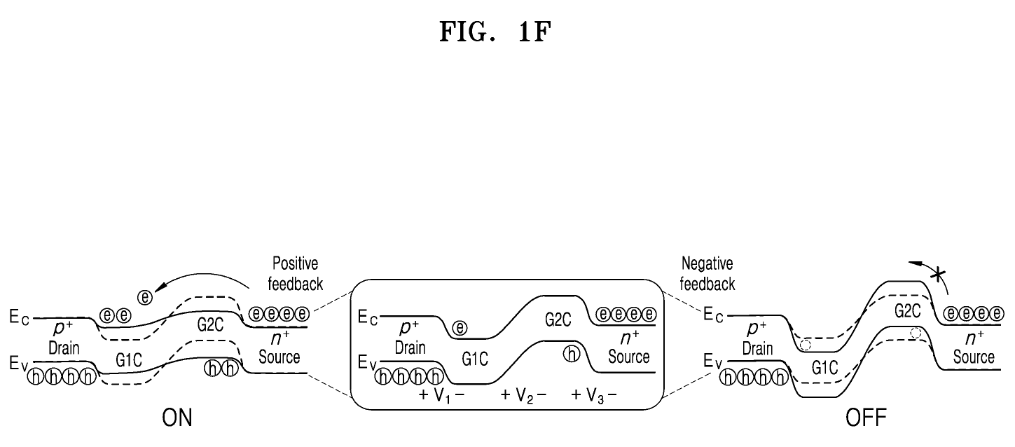

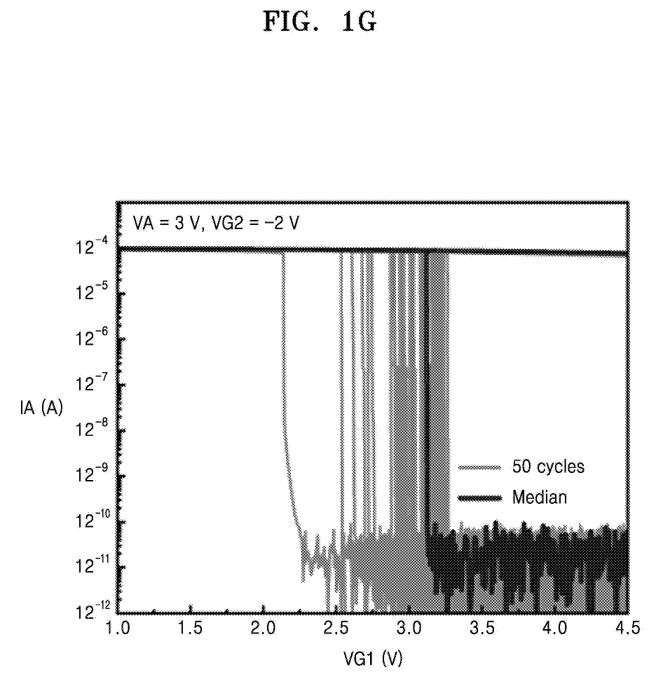

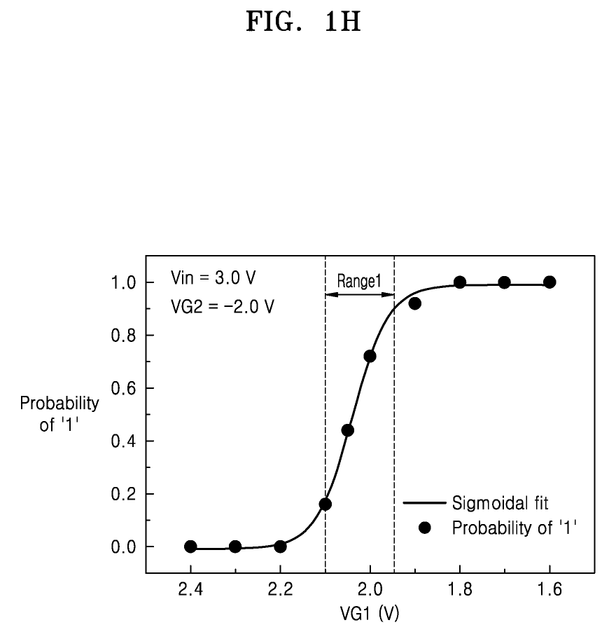

FIGS. 1A - 1I illustrate a true random number generator TRNG of a random number generation device 100 according to some embodiments.

FIG. 1A is a circuit diagram of the true random number generator TRNG. Referring to FIG. 1A, the random number generation device 100 may generate a random number based on a pulse signal Vin. The random number generation device 100 may include the true random number generator TRNG. The true random number generator TRNG may be a circuit configured to generate a random number based on hardware. The true random number generator TRNG may include a gated diode GD and a resistor R electrically connected in series to each other.

The gated diode GD may be referred to as a gated positive-intrinsic-negative (P-I-N or PIN) diode. The anode of the gated diode GD may receive the pulse signal Vin. The gated diode GD may receive a first gate voltage VG1 and a second gate voltage VG2 applied through gate electrodes thereof. In some embodiments, the first and second gate voltages VG1 and VG2 may have different voltage levels. One terminal of the resistor R may be electrically connected to the cathode of the gated diode GD, and the other terminal of the resistor R may be electrically connected to the output end of the random number generation device 100 or the ground.

In one cycle of the pulse signal Vin, when a certain voltage level generated during an on period corresponding to a pulse width is input to the true random number generator TRNG, an output current Iout may be output from the other terminal of the resistor R. The output current Iout may have a current value corresponding to a certain state among a plurality of states. For example, the plurality of states may include two states respectively corresponding to a binary random number "0" and a binary random number "1". For example, the plurality of states may include four states respectively corresponding to quaternary random numbers "0", "1", "2", and "3". For example, the plurality of states may include n states respectively corresponding to base-n random numbers "0" to "n-1". Because the current value of the output current Iout indicates one state and the one state corresponds to one random number, the current value of the output current Iout may indicate one random number.

FIG. 1B illustrates an optical image 110 of the gated diode GD (see FIG. 1A). Referring to FIG. 1B, the optical image 110 may include a polysilicon gate electrode, oxide embedded with a silicon dioxide (SiO₂) gate oxide layer, and a p⁺-i-n⁺ silicon nanosheet.

FIG. 1C is a structural diagram illustrating the gated diode GD. Referring to FIGS. 1A - 1C, the gated diode GD may have a p⁺-i-n⁺ doping structure and include four or more electrodes. For example, the gated diode GD may include a p⁺ region 120, an n⁺ region 121, an intrinsic region 122, a gate insulating region 123, a first gate region 124, a second gate region 125, an anode electrode 126, a cathode electrode 127, a first gate electrode 128, and a second gate electrode 129.

The p⁺ region 120 may be a doping region having a p-type doping state. The p-type doping state may indicate a state in which a dopant, such as boron (B), having fewer valence electrons than silicon (Si), is doped in a material, such as Si. A dopant having fewer valence electrons than Si may be referred to as a p-type dopant. A dopant may be referred to as an impurity. The n⁺ region 121 may be a doping region having an n-type doping state. The n-type doping state may be a state in which a dopant, such as phosphorous (P), having more valence electrons than Si, is doped in a material, such as Si. A dopant having more valence electrons than Si may be referred to as an n-type dopant. The intrinsic region 122 is an undoped region and may be between the p⁺ region 120 and the n⁺ region 121. The p⁺ region 120, the intrinsic region 122, and the n⁺ region 121 may be arranged side by side in a first direction D1.

The gate insulating region 123 may be stacked on the intrinsic region 122 in a second direction D2 and include oxide, such as SiO₂. The gate insulating region 123 may support each of the bottom of the first gate region 124 and the bottom of the second gate region 125. The first gate region 124 and the second gate region 125 may be disposed on the gate insulating region 123 and arranged side by side in the first direction D1. The first gate region 124 may be doped with a first dopant, and the second gate region 125 may be doped with a second dopant having characteristics different from those of the first dopant.

The anode electrode 126 may be disposed on the p⁺ region 120 and receive the pulse signal Vin. The cathode electrode 127 may be disposed on the n⁺ region 121 and electrically connected to the resistor R. The first and second gate electrodes 128 and 129 may be deposited above the intrinsic region 122. The first gate electrode 128 may be disposed on the first gate region 124 and receive the first gate voltage VG1. The second gate electrode 129 may be disposed on the second gate region 125 and receive the second gate voltage VG2.

In some embodiments, when the first gate region 124 and the first gate electrode 128 are adjacent to the p⁺ region 120 rather than the n⁺ region 121 and the second gate region 125 and the second gate electrode 129 are adjacent to the n⁺ region 121 rather than the p⁺ region 120, the first gate region 124 may include a material, such as n-doped polysilicon, the second gate region 125 may include a material, such as p-doped polysilicon, the first gate voltage VG1 may have a positive voltage level, and the second gate voltage VG2 may have a negative voltage level.

In another embodiment, unlike shown in FIG. 1C, when the first gate region 124 and the first gate electrode 128 are adjacent to the n⁺ region 121 and the second gate region 125 and the second gate electrode 129 are adjacent to the p⁺ region 120, the first gate region 124 may include a material, such as p-doped polysilicon, the second gate region 125 may include a material, such as n-doped polysilicon, the first gate voltage VG1 may have a negative voltage level, and the second gate voltage VG2 may have a positive voltage level.

The gated diode GD may be prepared on a p-type silicon-on-insulator wafer by using a fully complementary metal-oxide-semiconductor (CMOS)-compatible top-down process. For example, a silicon active layer having a thickness of about 100nm may be patterned with a width of about 180nm by using photolithography and a dry etching process. Polysilicon gates having a thickness of about 400nm and a length of about 1.5μm may be formed with a gap of about 1μm by low-pressure chemical vapor deposition (LPCVD) on an SiO₂ gate oxide layer having a thickness of about 25nm, which is thermally grown in a unique channel region at about 850 °C. The p+ region 120, the first gate region 124, and the cathode electrode 127 may be doped in a high concentration with p+ ions having a capacity of about 3×1015 cm-2 at about 50 keV, and the n+ region 121, the second gate region 125, and the anode electrode 126 may be doped in a high concentration with BF₂+ ions having a capacity of about 3×1015 cm-2 at about 30 keV. A dopant may be thermally activated at about 1050 °C for about 30 seconds. Titanium (Ti), titanium nitride (TiN), aluminum (Al), or a TiN metal alloy may be deposited on anode, cathode, and gate contact regions after depositing an interlayer insulating layer at about 400 °C for about 30 minutes.

FIG. 1D illustrates a potential well and a potential barrier of the gated diode GD. Referring to FIGS. 1C and 1D, because the first gate region 124 is doped with a first dopant (e.g., a p-type dopant) and the second gate region 125 is doped with a second dopant (e.g., an n-type dopant), a potential barrier by electrostatic doping may be formed in the intrinsic region 122.

FIG. 1E is a graph illustrating the switching characteristic of the gated diode GD. Referring to FIGS. 1C - 1E, the graph shown in FIG. 1E shows a relationship between a voltage VA and a current IA when, in the gated diode GD, the first gate region 124 includes n-doped polysilicon, the second gate region 125 includes a material, such as p-doped polysilicon, the first gate voltage VG1 is applied as a positive voltage, and the second gate voltage VG2 is applied as a negative voltage. The voltage VA may be an anode voltage applied to the anode electrode 126, for example, a voltage having a voltage level during an on period of the pulse signal Vin. The current IA may be an anode current or a drain-source current (e.g., IDS), for example, the output current Iout. The graph shows a sharp switching characteristic of the drain-source current, wherein the energy band structure of a channel region changes to p⁺-n^{*}-p^{*}-n⁺ due to electrostatic doping of the first and second gate regions 124 and 125 and the first and second gate voltages VG1 and VG2, and the latch-up characteristic (or latch-up phenomenon) and the latch-down characteristic (or latch-down phenomenon) of the gated diode GD according to the generation and extinction of a positive feedback loop. Herein, n^{*} denotes n-type electrostatic doping and p^{*} denotes p-type electrostatic doping. The latch-up characteristic indicates a sharp increase in the current IA, and the latch-down characteristic indicates a sharp decrease in the current IA.

FIG. 1F illustrates a change in the energy band of the gated diode GD. Referring to FIGS. 1C - 1F, when charges are sufficiently injected, a positive feedback loop may be formed, and as some charges accumulate inside a channel, the potential barrier may be lowered or eliminated such that the latch-up characteristic appears, and the gated diode GD may be turned on (or in an on state) such that a current flows through the gated diode GD. When the injection of charges is insufficient, a negative feedback loop may be formed. As electrons and holes accumulated inside the channel recombine, the potential barrier may be restored, resulting in the manifestation of a latch-down characteristic, and the gated diode GD may be turned off (or in an off state) such that no current flows through the gated diode GD.

FIG. 1G is a graph illustrating a distribution of a latch-up voltage according to the latch-up characteristic of the gated diode GD. Referring to FIGS. 1C - 1G, the gated diode GD may operate as a positive feedback loop by an interaction between the charges and the potential barrier of the intrinsic region 122, and may have a characteristic that a latch-up voltage varies even in the same voltage condition due to random generation and recombination processes of charges in the intrinsic region 122. Due to the characteristic of the gated diode GD having a latch-up voltage varying with respect to the same pulse signal Vin (e.g., an anode voltage VA) and the first and second gate voltages VG1 and VG2, the true random number generator TRNG may randomly generate a bit value "0" and a bit value "1".

FIGS. 1H and 1I are graphs illustrating a probabilistic region of the gated diode GD according to a voltage condition. Referring to FIGS. 1F, 1H, and 1I, the probabilities shown in FIGS. 1H and 1I may be probabilities of generating the bit value "1" by one true random number generator TRNG configured to generate a binary random number. A condition in which the probability is 0 indicates that the height of a potential barrier is high enough to prevent the injection of carriers from an anode. A condition in which the probability is 1 indicates that the height of a potential barrier is low enough to allow the injection of carriers to a channel fully. The voltage condition may include the pulse signal Vin, the first gate voltage VG1, and/or the second gate voltage VG2.

Referring to FIG. 1H, it is assumed that, in the voltage condition, the voltage level of each of the pulse signal Vin and the second gate voltage VG2 is a constant, and the voltage level of the first gate voltage VG1 is a variable. When the first gate voltage VG1 is adjusted, the height of the potential barrier of the gated diode GD may change so as to adjust the amount of charges injected into the intrinsic region 122, thereby changing the probability of generating the bit value "1". As the voltage level of the first gate voltage VG1 decreases, the probability may increase from 0 to 1 in the form of a sigmoidal function. Because the height of the potential barrier in a first probabilistic region Range1, in which the probability of generating the bit value "1" is 0 to 1, is closely associated with the number of charge carriers accumulated in a potential well, the height of the potential barrier may randomly vary due to the probabilistic characteristic of a carrier recombination process. In this case, when the first gate voltage VG1 is set within the first probabilistic region Range1, a random number may be relatively randomly generated.

Referring to FIG. 1I, it is assumed that, in the voltage condition, the voltage level of each of the pulse signal Vin and the first gate voltage VG1 is a constant and the voltage level of the second gate voltage VG2 is a variable. As the voltage level of the second gate voltage VG2 increases, the probability may increase from 0 to 1 in the form of a sigmoidal function. In this case, when the second gate voltage VG2 is set within a second probabilistic region Range2, a random number may be relatively randomly generated. In some embodiments, the size of the second probabilistic region Range2 may be greater than the size of the first probabilistic region Range1. The size of a probabilistic region may vary according to a set voltage condition. In addition, due to a difference in a process, the shape of a graph showing a probability may vary for each gated diode GD, even in the same voltage condition.

As shown in FIGS. 1H and 1I, the first gate voltage VG1 and/or the second gate voltage VG2 may control the probability of the bit value "1", and thus, the true random number generator TRNG according to the disclosure may be applied to probabilistic computing. In FIGS. 1H and 1I, the respective voltage levels of the pulse signal Vin, the first gate voltage VG1, and the second gate voltage VG2 are only illustrative, and the voltage levels described above are not limited to the embodiments.

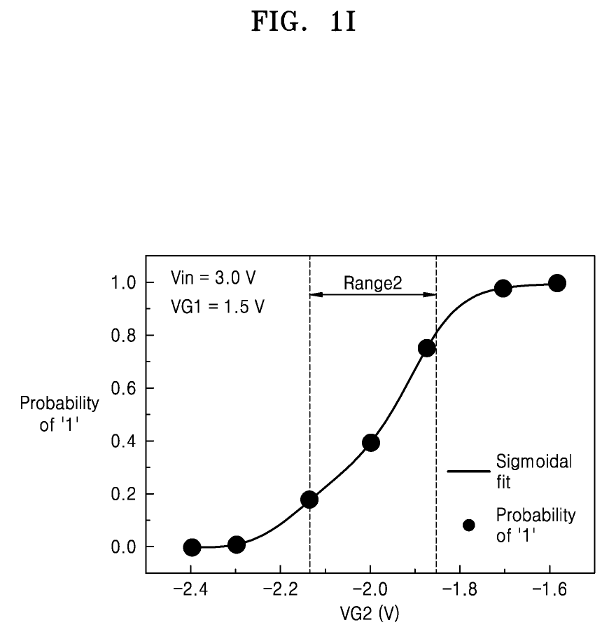

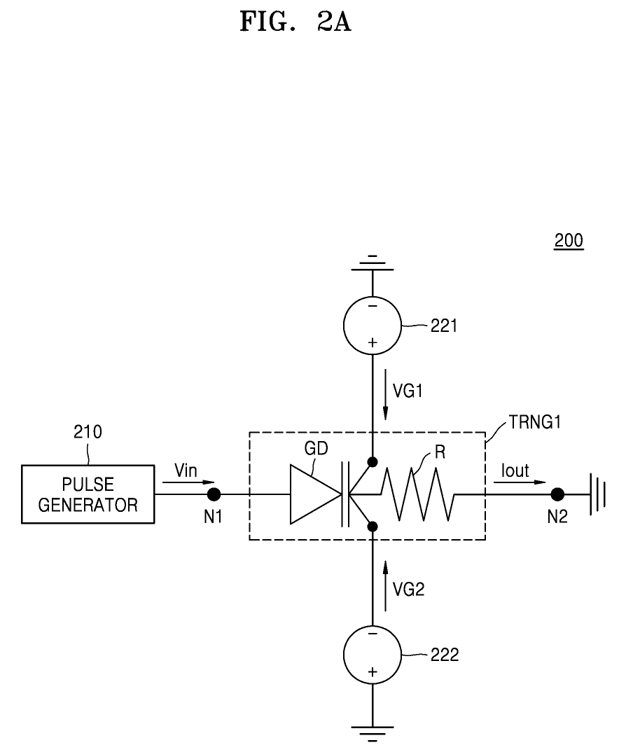

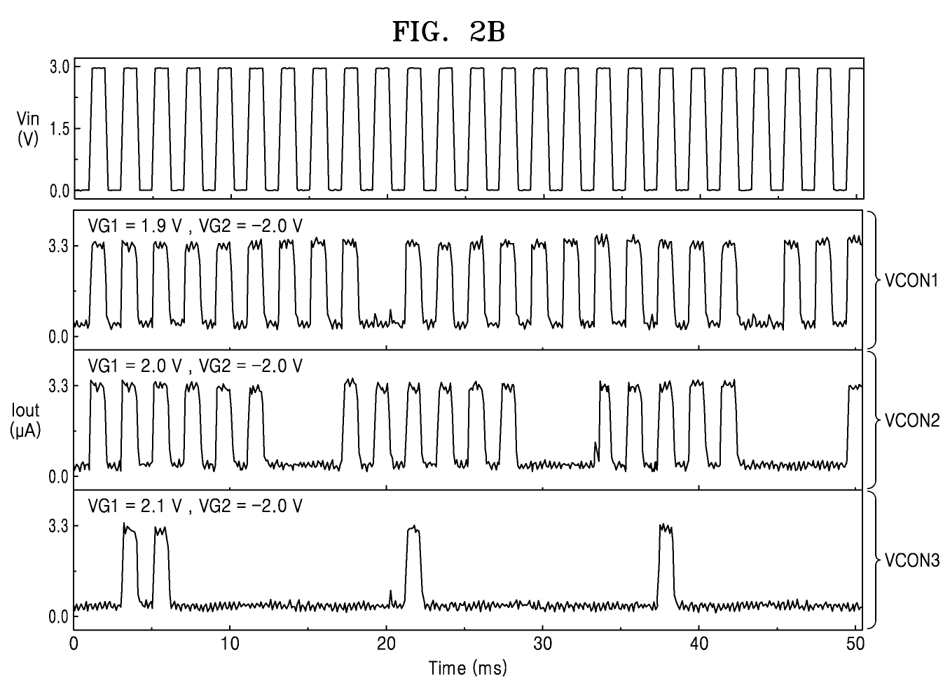

FIGS. 2A and 2B illustrate a binary random number generation device 200 according to some embodiments.

FIG. 2A is a circuit diagram of the binary random number generation device 200. Referring to FIG. 2A, the binary random number generation device 200 may generate a binary random number. The binary random number generation device 200 may include a pulse generator 210, a first true random number generator TRNG1, and a voltage source circuit. The pulse generator 210 may output the pulse signal Vin. The pulse signal Vin may maintain a constant duty ratio, exhibit a voltage level during an on period of each cycle, and have a constant cycle period. The first true random number generator TRNG1 may include the gated diode GD and the resistor R electrically connected in series to each other, as described above with reference to FIG. 1A. The anode electrode 126 (see FIG. 1C) of the gated diode GD may be electrically connected to the pulse generator 210 via a first node N1. One terminal of the resistor R may be electrically connected to the cathode electrode 127 (see FIG. 1C) of the gated diode GD, and the other terminal of the resistor R may be electrically connected to a second node N2. The second node N2 is an output node and may be a point electrically connected to another component. The voltage source circuit may generate the first and second gate voltages VG1 and VG2. In some embodiments, the voltage source circuit may include a first voltage source 221 and a second voltage source 222. The first voltage source 221 may provide the first gate voltage VG1 corresponding to a positive voltage to the first gate electrode 128 (see FIG. 1C) of the gated diode GD. The second voltage source 222 may provide the second gate voltage VG2 corresponding to a negative voltage to the second gate electrode 129 (see FIG. 1C) of the gated diode GD. The output current Iout from the first true random number generator TRNG1 may have a first current value or a second current value.

FIG. 2B is a timing diagram illustrating the output current Iout of the binary random number generation device 200 (see FIG. 2A) according to voltage conditions. Referring to FIGS. 1H and 2B, it is assumed that the voltage level of the pulse signal Vin is 3V during an on period and 0V during an off period in one cycle. The output current Iout may be the first current value, e.g., about 0μA (or a weak current value greater than 0 and less than 1), or the second current value, e.g., about 3.3μA. The first current value may correspond to a first state indicating "0" in binary, and the second current value may correspond to a second state indicating "1" in binary. That is, the first true random number generator TRNG1 may randomly generate the output current Iout of 0.0μA or 3.3μA, indicating a random number "0" or "1", respectively. Because the binary random number generation device 200 has stable durability, the current value of the output current Iout corresponding to each state may be stably maintained for about thousands of cycles. It is assumed that, in a first voltage condition VCON1, the first gate voltage VG1 is 1.9V and the second gate voltage VG2 is -2.0V. In the first voltage condition VCON1, as shown in FIG. 1H, a probability is about 0.9, and thus, the output current Iout having the first current value (e.g., 3.3μA) may be frequently generated. That is, "1" in binary may be frequently generated as a random number. It is assumed that, in a second voltage condition VCON2, the first gate voltage VG1 is 2.0V and the second gate voltage VG2 is -2.0V. In the second voltage condition VCON2, as shown in FIG. 1H, a probability is about 0.7, and thus, the output current Iout having the first current value may be relatively less generated when compared to the first voltage condition VCON1. It is assumed that, in a third voltage condition VCON3, the first gate voltage VG1 is 2.1V and the second gate voltage VG2 is -2.0V. In the third voltage condition VCON3, as shown in FIG. 1H, a probability is about 0.2, and thus, the output current Iout having the first current value may be relatively less generated when compared to the first and second voltage conditions VCON1 and VCON2. As described above, because a probability of generating the bit value "1" or a probability of generating the output current Iout having the first current value varies according to a voltage condition, it is preferable to design the voltage condition such that the probability is set to about 0.5.

As described above, the binary random number generation device 200 may be implemented with a simple structure, without requiring an additional circuit to convert an entropy source into a random number, by utilizing the aforementioned characteristic that the latch-up voltage of the gated diode GD varies. Accordingly, a low-power operation may be performed with a low operating voltage, miniaturization may be achieved, and a manufacturing cost may be saved.

In addition, as described above, by adjusting the probability of a random bit string based on a voltage form of the pulse signal Vin input to the binary random number generation device 200, the first true random number generator TRNG1 of the binary random number generation device 200 may be used to implement probabilistic computing.

In addition, as described above, by preparing the gated diode GD by using an existing CMOS process, a random number may be stably generated, the binary random number generation device 200 may be mass-produced, and the binary random number generation device 200 may be commercialized.

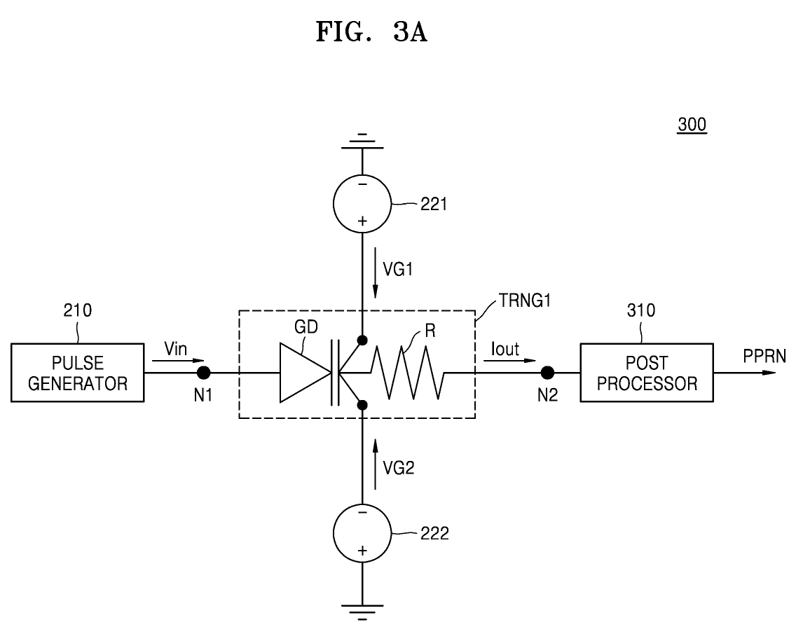

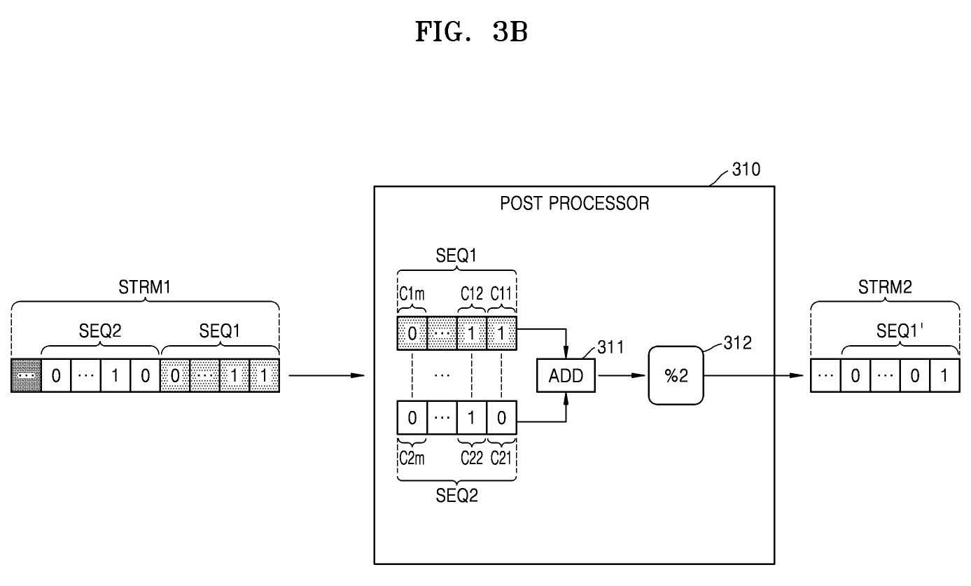

FIGS. 3A and 3B illustrate a binary random number generation device 300 according to another embodiment.

FIG. 3A is a circuit diagram of the binary random number generation device 300. The description made above with reference to FIG. 2A is not repeated with reference to FIG. 3A. Referring to FIG. 3A, the binary random number generation device 300 may include the pulse generator 210, the first true random number generator TRNG1, and the voltage source circuit including the first and second voltage sources 221 and 222,and may further include a post processor 310. The post processor 310 may be electrically connected to the other terminal of the resistor R via the second node N2. The post processor 310 may generate a post-processed random number PPRN based on the output current Iout. In embodiments, the post processor 310 may generate a plurality of post-processed random numbers PPRN based on a random sequence including a plurality of random numbers of a plurality of output currents.

FIG. 3B illustrates an operation of the post processor 310. Referring to FIG. 3B, a first data stream STRM1 may be input to the post processor 310. The first data stream STRM1 may include random numbers sequentially generated over time. The post processor 310 may divide the first data stream STRM1 into random sequence units and perform a post processing operation based on two random sequences. A random sequence may include random numbers, each having a preset number of digits. For example, the post processor 310 may receive a first random sequence SEQ1 and a second random sequence SEQ2 each including m random numbers in the first data stream STRM1, add random numbers at the same places in the first and second random sequences SEQ1 and SEQ2, and generate, as a post-processed random number PPRN, the remainder obtained by dividing the addition result by 2 (e.g., a remainder operation or a modulo operation). For example, a random number placed in a first random number column C11 of the first random sequence SEQ1 is 1, and a random number placed in a first random number column C21 of the second random sequence SEQ2 is 0. The value obtained by adding 1 and 0 is 1, the remainder obtained by dividing 1 by 2 is 1, and thus, 1 may be output. Next, the value obtained by adding random numbers placed in second random number columns C12 and C22 of the first and second random sequences SEQ1 and SEQ2 is 2, the remainder obtained by dividing 2 by 2 is 0, and thus, 0 may be output next to 1. The post processing operation may be repeated in the same manner, and when the post processing operation using random numbers placed in m-th random number columns C1m and C2m of the first and second random sequences SEQ1 and SEQ2 is performed, 0 may be output. By sequentially outputting other random sequences next to a first random sequence SEQ1' in the same manner, a second data stream STRM2 may be output from the post processor 310. The number of digits of the first data stream STRM1 may be the same as the number of digits of the second data stream STRM2.

As described above, the post processor 310 may be used to ensure complicated randomness, thereby further improving the security strength. However, to efficiently encrypt rapidly increasing data, a multinary (binary or above) true random number generator is required.

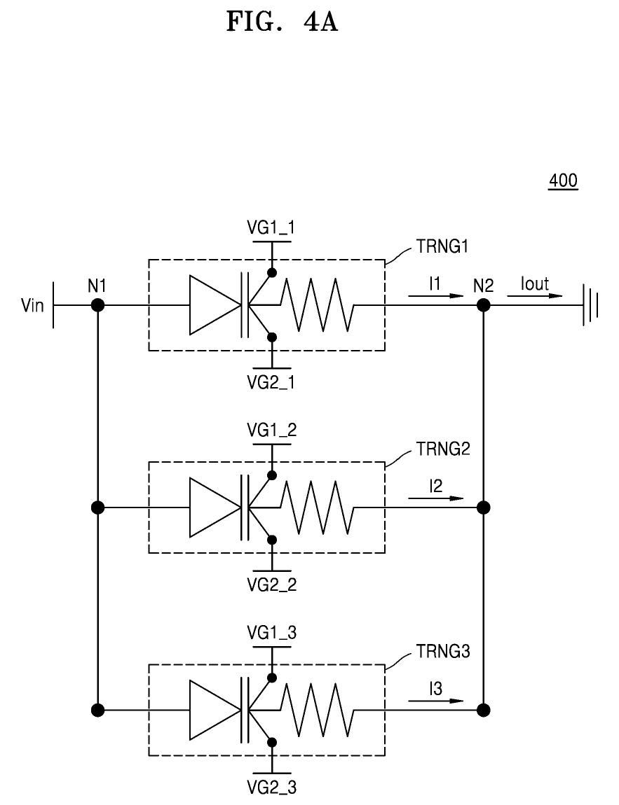

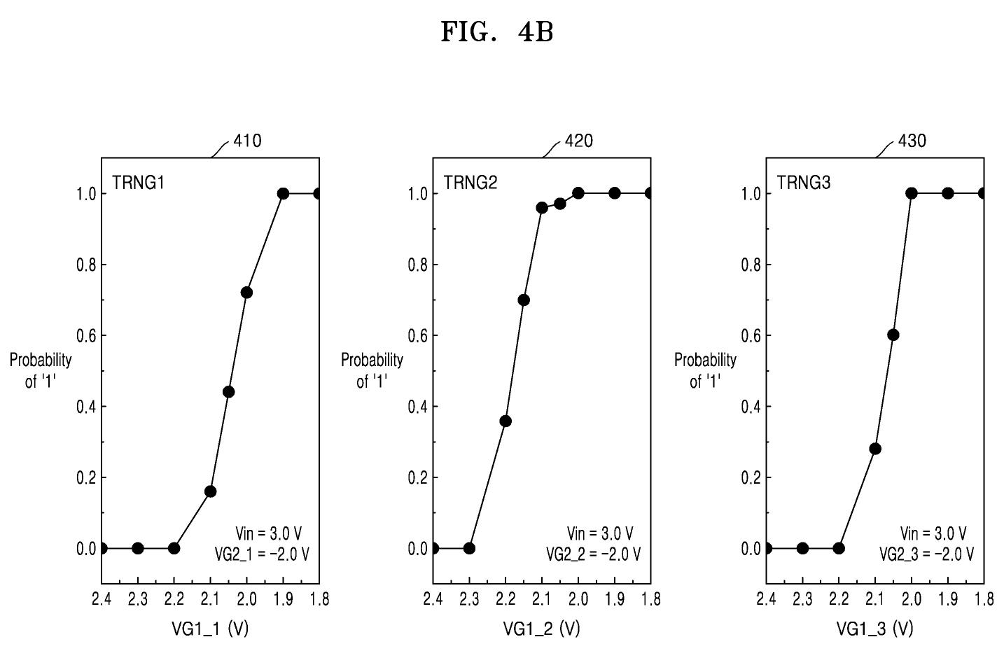

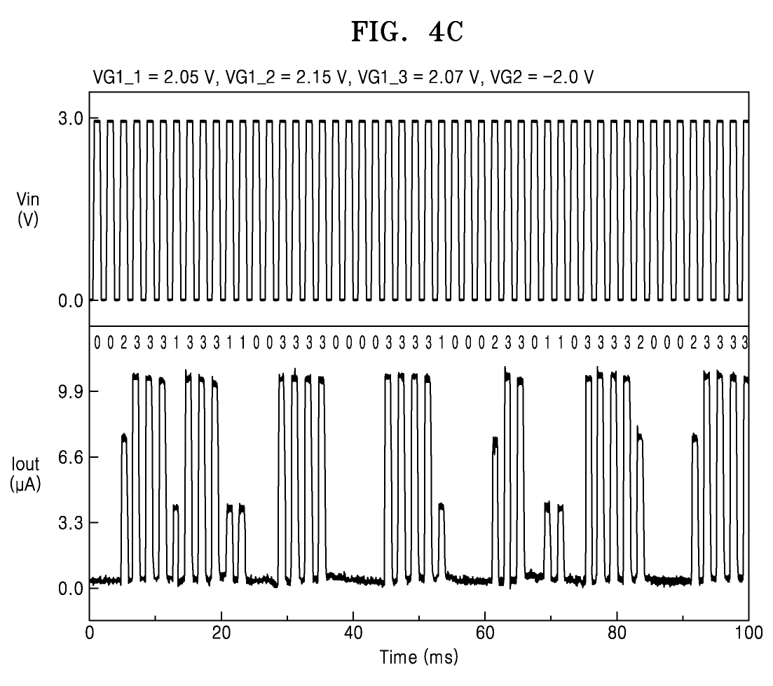

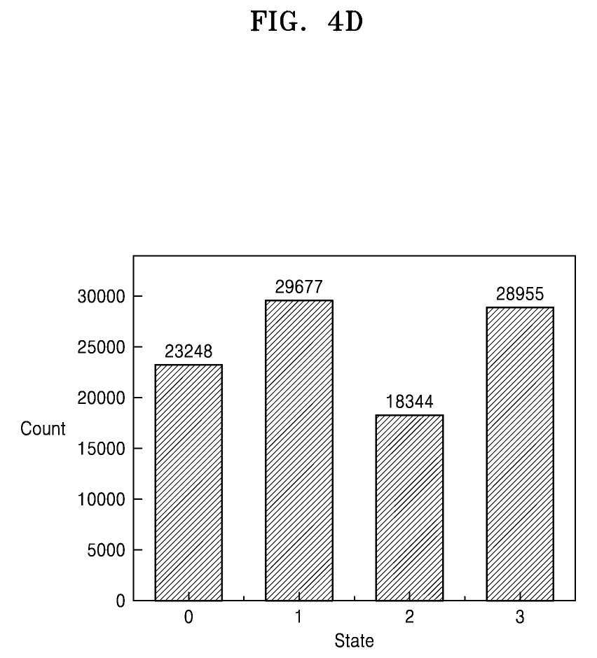

FIGS. 4A - 4D illustrate a quaternary random number generation device 400 according to some embodiments.

FIG. 4A is a circuit diagram of the quaternary random number generation device 400. The description made above with reference to FIG. 2A is not repeated with reference to FIG. 4A. Referring to FIG. 2A, the quaternary random number generation device 400 may generate a quaternary random number. The quaternary random number generation device 400 may include first to third true random number generators TRNG1, TRNG2, and TRNG3. Although not shown in FIG. 4A, the quaternary random number generation device 400 may include a pulse generator and a voltage source circuit. The first to third true random number generators TRNG1, TRNG2, and TRNG3 may be binary true random number generators electrically connected in parallel between the first node N1 and the second node N2. Each of the first to third true random number generators TRNG1, TRNG2, and TRNG3 may receive the pulse signal Vin. The first true random number generator TRNG1 may receive first and second gate voltages VG1_1 and VG2_1, the second random number generator TRNG2 may receive first and second gate voltages VG1_2 and VG2_2, and the third random number generator TRNG3 may receive first and second gate voltages VG1_3 and VG2_3. In some embodiments, the voltage source circuit of the quaternary random number generation device 400 may include three first voltage sources and at least one second voltage source. The sum of the first to third currents I1, I2, and I3, respectively output from the first to third true random number generators TRNG1, TRNG2, and TRNG3, may be the output current Iout. Every time a pulse of the pulse signal Vin is generated, the output current Iout may have any one current value among the first to third current values. A quaternary random number randomly indicating any one state among four states (or four digits) may be generated through the output current Iout. The current value of the output current Iout corresponding to each state may be stably maintained for about thousands of cycles (e.g., 2,000 cycles and corresponding to about 1ⅹ10⁵ bits).

FIG. 4B are first to third graphs 410, 420, and 430 illustrating the probabilistic regions of the first to third true random number generators TRNG1, TRNG2, and TRNG3, respectively. The description made above with reference to FIG. 1H is not repeated with reference to FIG. 4B. Referring to FIG. 4B, for voltage conditions set with respect to the first to third true random number generators TRNG1, TRNG2, and TRNG3, it is assumed that the pulse signal Vin and the second gate voltages VG2_1, VG2_2, and VG2_3 are constant. The first graph 410 illustrates the probability of generating the bit value "1" by the first true random number generator TRNG1 of FIG. 4A. The second graph 420 illustrates the probability of generating the bit value "1" by the second random number generator TRNG2 of FIG. 4A. The third graph 430 illustrates the probability of generating the bit value "1" by the third random number generator TRNG3 of FIG. 4A. The shapes of the first to third graphs 410, 420, and 430 may be different from each other by the respective physical characteristics of the first to third true random number generators TRNG1, TRNG2, and TRNG3. For example, when the first gate voltages VG1_1, VG1_2, and VG1_3 are 2.1V, the probabilities of generating the bit value "1" by the first to third true random number generators TRNG1, TRNG2, and TRNG3 are about 0.2, about 1, and about 0.3, respectively. Therefore, a voltage condition corresponding to an appropriate probabilistic region may vary for each of the first to third true random number generators TRNG1, TRNG2, and TRNG3, and to set the probabilities of the first to third true random number generators TRNG1, TRNG2, and TRNG3 to be the same as or similar to each other, the first gate voltages VG1_1, VG1_2, and VG1_3 may be differently set and applied based on respective probability change graphs of the first to third true random number generators TRNG1, TRNG2, and TRNG3.

FIG. 4C is a timing diagram illustrating the output current Iout of the quaternary random number generation device 400 in a certain voltage condition. The description made above with reference to FIG. 2B is not repeated with reference to FIG. 4C. Referring to FIGS. 4B and 4C, it is assumed that the first gate voltages VG1_1, VG1_2, and VG1_3 are 2.05V, 2.15V, and 2.07V, respectively, and the second gate voltage VG2 representative of the second gate voltages VG2_1, VG2_2, and VG2_3 is -2.0V. In this case, the probability of each of the first to third true random number generators TRNG1, TRNG2, and TRNG3 may be about 0.5. Every time a pulse of the pulse signal Vin is repeated, the output current Iout having any one current value among the first to fourth current values may be generated. For example, the first current value may correspond to a first state indicating "0" in quaternary and may be about 0μA (or a weak current value greater than 0 and less than 1). The second current value may correspond to a second state indicating "1" in quaternary and may be about 3.3μA. The third current value may correspond to a third state indicating "2" in quaternary and may be about 6.6μA. The fourth current value may correspond to a fourth state indicating "3" in quaternary and may be about 9.9μA. As described above, the output current Iout for indicating "0", "1", "2", or "3" in quaternary may be randomly generated.

As described above, by efficiently encrypting rapidly increasing data based on the quaternary random number generation device 400, the amount of data processing may be reduced. In particular, when data is encrypted using the quaternary random number generation device 400 in the image processing field, the amount of data processing required for image encryption may be reduced by 50 % or more than that when using a binary true random number generator.

In addition, as described above, because of the sharp switching characteristic of the gated diode GD, a quaternary random number of the quaternary random number generation device 400 may be clearly identified, even without an auxiliary circuit configured to convert an entropy source into a random number. Therefore, the integration and miniaturization of the quaternary random number generation device 400 may be possible.

In addition, as described above, the output current Iout having a current value corresponding to each state is stably maintained, even when operating for thousands of cycles, and thus, the quaternary random number generation device 400 may have stable durability. This durability characteristic is related to a fundamental limitation to the length of a sequence including random numbers and may contribute to long-term reliability and suitability on a difficult calculation operation.

FIG. 4D is a graph illustrating occurrence counts of four states of the quaternary random number generation device 400. Referring to FIG. 4D, the deviation between occurrence counts of states may be relatively large. In this case, because an occurrence count of a certain state may be relatively large, along with the development of hacking technology, a quaternary random number generated by the quaternary random number generation device 400 may be predicted by an attacker. Therefore, a high level of randomness uniformly distributed for all numbers in a sequence may be required to reinforce a security level.

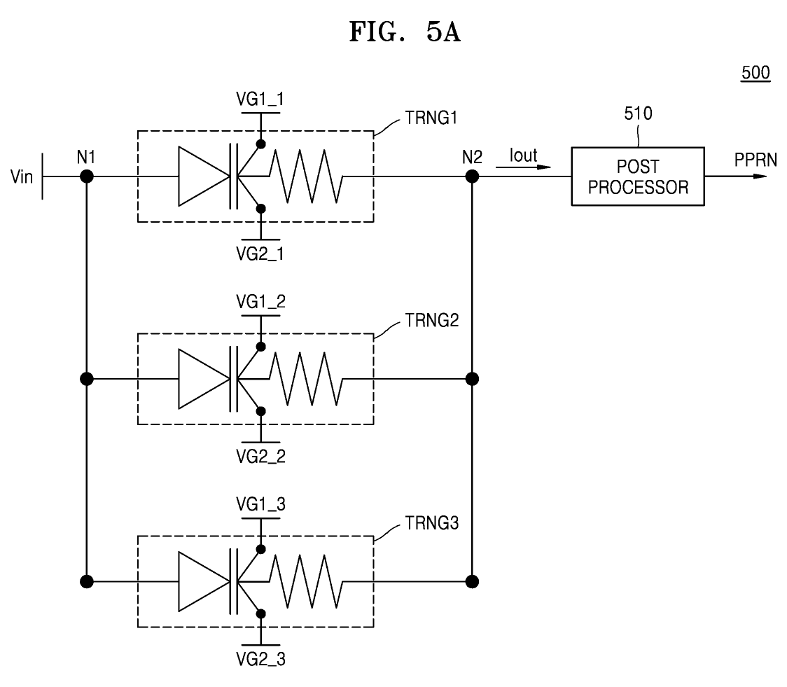

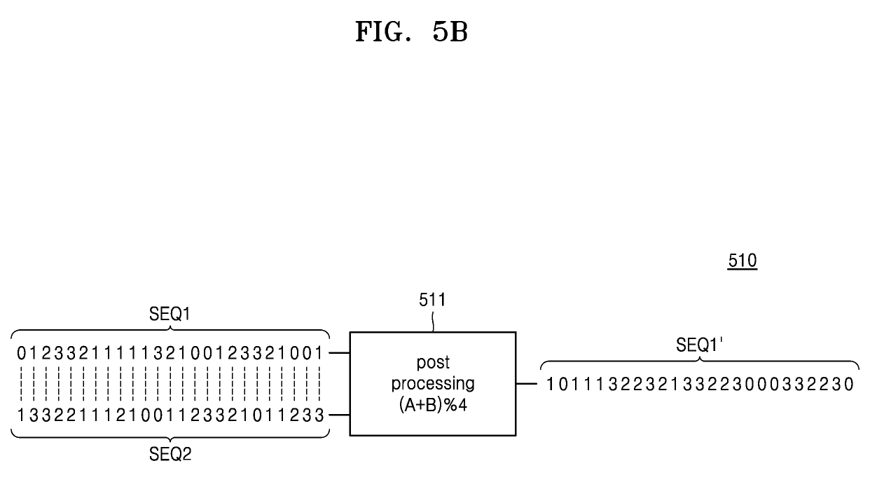

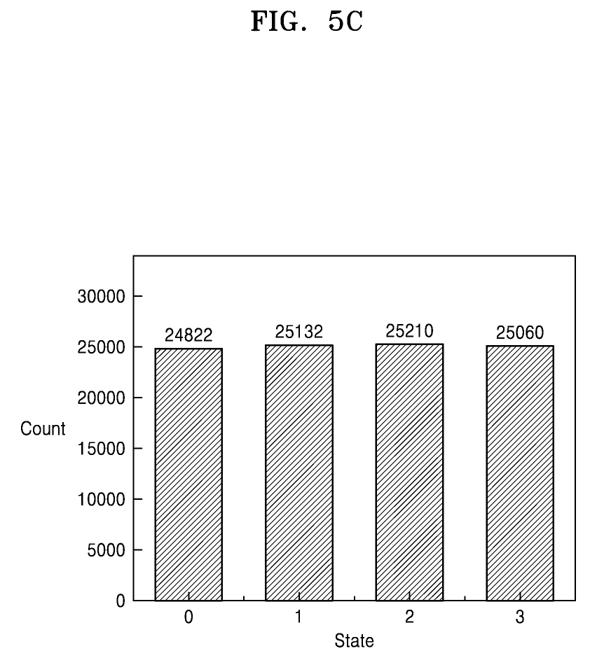

FIGS. 5A, 5B, and 5C illustrate a quaternary random number generation device 500 according to another embodiment. Particularly, FIG. 5A is a circuit diagram of the quaternary random number generation device 500, FIG. 5B illustrates an operation of a post processor 510, and FIG. 5C is a graph illustrating occurrence counts of four states of the quaternary random number generation device 500. The description provided with reference to FIGS. 4A and 3B is not repeated with reference to FIGS. 5A, 5B, and 5C.

Referring to FIG. 5A, the quaternary random number generation device 500 may further include the post processor 510 in addition to the quaternary random number generation device 400. Referring to FIG. 5B, a first random sequence SEQ1 and a second random sequence SEQ2 may be sequentially input to the post processor 510. The post processor 510 may add random numbers at the same places in the first and second random sequences SEQ1 and SEQ2, generate, as a post-processed random number PPRN (see FIG. 5A), the remainder obtained by dividing the addition result by 4, and output a random sequence, e.g., a first random sequence SEQ1', including post-processed random numbers PPRN. For example, the value obtained by adding 1 and 3 is 4, and the remainder obtained by dividing 4 by 4 is 0. The value obtained by adding 0 and 3 is 3, and the remainder obtained by dividing 3 by 4 is 3. Likewise, any one value among 0 to 3 may be output by a post processing operation 511 on a combination of selecting two numbers among 0, 1, 2, and 3. The post processor 510 may perform the post processing operation 511 on the following random sequences. Referring to FIG. 5C, the deviation between occurrence counts of states may be relatively less than the deviation shown in FIG. 4D. In this case, the occurrence count of each of the four states is uniform, and thus, a quaternary random number generated by the quaternary random number generation device 500 may be difficult to predict. Therefore, the security strength of the quaternary random number generation device 500 may be higher than the security strength of the quaternary random number generation device 400.

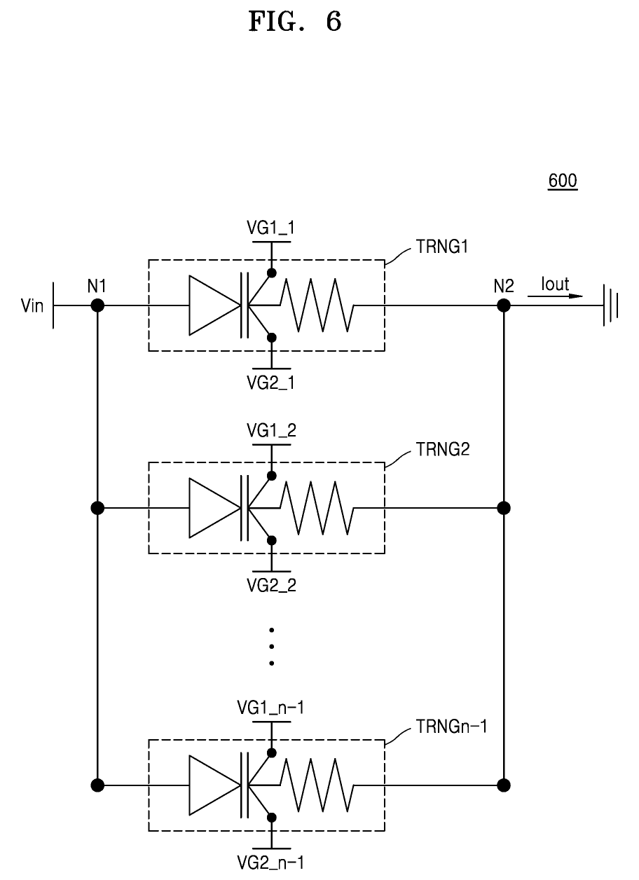

FIG. 6 illustrates a multinary random number generation device 600 according to some embodiments. The description made above is not repeated with reference to FIG. 6.

Referring to FIG. 6, the multinary random number generation device 600 may generate a multinary random number. Herein, multinary may indicate binary or above and may be referred to as base n. Herein, n may be an integer greater than or equal to 2, for example, 2, 4, 16, or 256. However, the disclosure is not limited thereto. The multinary random number generation device 600 may include first to (n-1)-th true random number generators TRNG1 to TRNGn-1 electrically connected in parallel to each other. Although not shown in FIG. 6, the multinary random number generation device 600 may include a pulse generator and a voltage source circuit. In addition, the multinary random number generation device 600 may further include a post processor. In embodiments, to set the probabilities of the first to (n-1)-th true random number generators TRNG1 to TRNGn-1 to be the same as or similar to each other, first gate voltages VG1_1 to VG1_n-1 and second gate voltages VG2_1 to VG2_n-1 to be applied to the first to (n-1)-th true random number generators TRNG1 to TRNGn-1 may be determined, respectively. In some embodiments, the first gate voltages VG1_1 to VG1_n-1 may have the same polarity (e.g., a positive voltage), the second gate voltages VG2_1 to VG2_n-1 may have the same polarity (e.g., a negative voltage), and the polarity of the first gate voltages VG1_1 to VG1_n-1 may be different from the polarity of the second gate voltages VG2_1 to VG2_n-1. In some embodiments, the voltage levels of the second gate voltages VG2_1 to VG2_n-1 may be the same as each other. Every time a pulse of the pulse signal Vin is generated, the output current Iout may have any one current value among the first to (n-1)-th current values.

As described above, by adjusting the probability of a random bit string based on a voltage-type pulse signal Vin, the first to (n-1)-th true random number generators TRNG1 to TRNGn-1 may be used for probabilistic computing. In addition, by generating a multinary random number without an additional circuit, the multinary random number generation device 600 may be miniaturized. In addition, by preparing the multinary random number generation device 600 through an existing CMOS process, the multinary random number generation device 600 may be mass-produced and commercialized. In addition, by using the multinary random number generation device 600 based on Si, the amount of data processing may be reduced. In addition, by generating a multinary (binary or above) random number, the data processing speed and the amount of power consumption may be reduced.

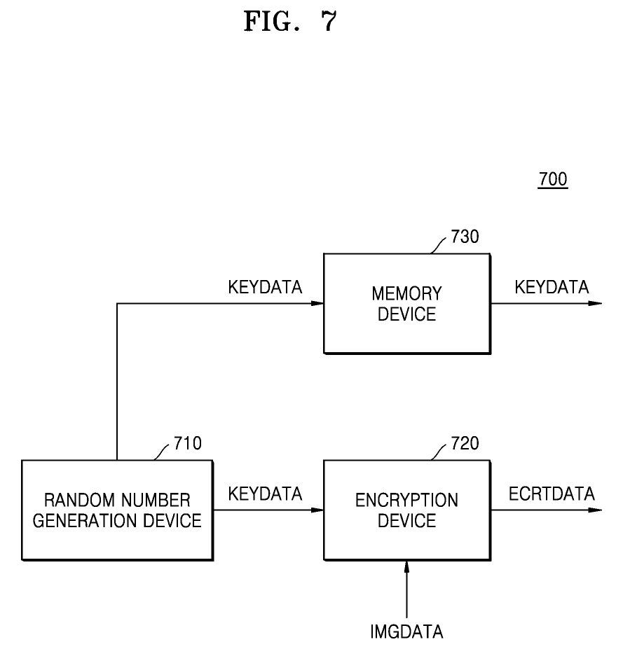

FIG. 7 is a block diagram of a crypto system 700 according to some embodiments. The description made above is not repeated with reference to FIG. 7.

Referring to FIG. 7, the crypto system 700 may encrypt information, such as an image, by using a security key including base-n random numbers. The crypto system 700 may include a random number generation device 710, an encryption device 720, and a memory device 730.

The random number generation device 710 may generate key data KEYDATA including a plurality of random numbers constituting a security key. The random number generation device 710 may correspond to the multinary random number generation device 600 of FIG. 6. The random number generation device 710 may provide the key data KEYDATA to each of the encryption device 720 and the memory device 730. Image data IMGDATA may be provided by a storage device, a source device, and/or the like. In some embodiments, the random number generation device 710 may include a pulse generator, a voltage source circuit, and a plurality of true random number generators configured to generate a multinary random number for a pulse signal, based on the pulse signal and a plurality of gate voltages.

In embodiments, compared to a device configured to generate a random number by using a single-photon avalanche diode (SPAD) array or a device configured to generate a random number by using dispersion of each radiation or a breakdown voltage generation sequence of a diode as an entropy source of a physical unclonable function (PUF) in a structure including a P-I-N diode and a resistor, the random number generation device 710 may operate as a feedback loop by an interaction between charges and a potential barrier of the gated diode GD including a gate region and a gate voltage. In addition, the random number generation device 710 may have a structure in which binary true random number generators each including the gated diode GD and the resistor R electrically connected in series to each other are electrically connected in parallel to each other. In addition, the random number generation device 710 may receive a voltage periodically applied thereto, periodically generate a current by a positive feedback loop, and generate a multinary random number according to probabilistic switching by a change in a latch-up voltage. The random number generation device 710 may continuously output multinary random number columns as current values over time and generate a long random sequence in a single structure.

The encryption device 720 may receive the image data IMGDATA including a plurality of pixel values constituting an image and the key data KEYDATA, and generate encrypted data ECRTDATA by using the image data IMGDATA and the key data KEYDATA.

The memory device 730 may store the key data KEYDATA. The memory device 730 may output the key data KEYDATA under control by a processor, a memory controller, or the like.

The encrypted data ECRTDATA and the key data KEYDATA may be stored in a system including the crypto system 700 or transmitted to an external system of the system by communicating with the external system.

The external system may receive the encrypted data ECRTDATA and the key data KEYDATA from the crypto system 700 and perform a decryption operation similar to an encryption operation of the encryption device 720, by using the encrypted data ECRTDATA and the key data KEYDATA. Once the decryption operation is performed, the encrypted data ECRTDATA may be restored to the image data IMGDATA.

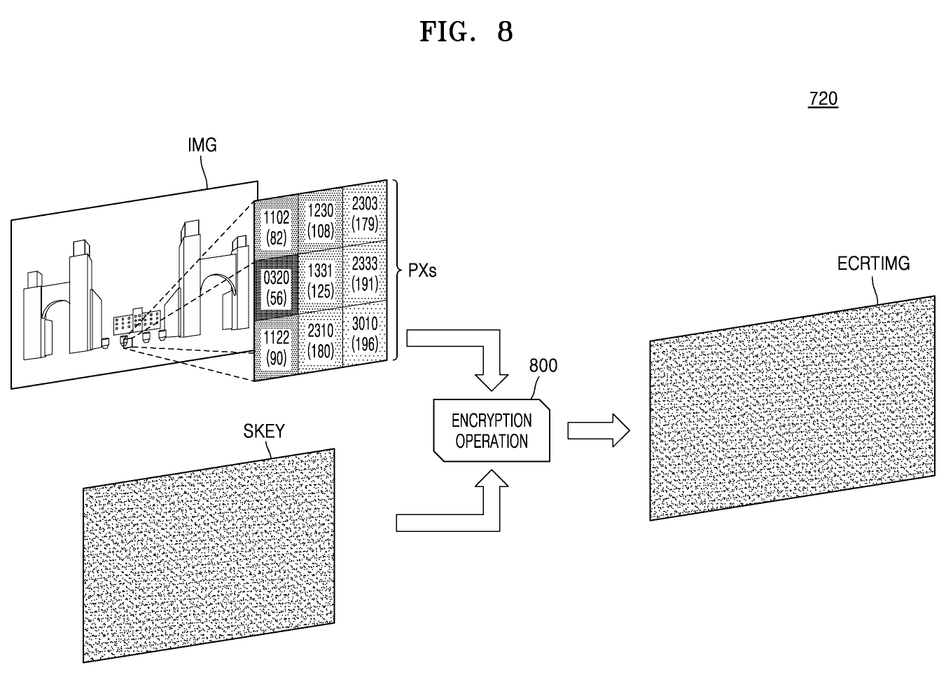

FIG. 8 illustrates an image, a security key, and an encrypted image according to some embodiments.

Referring to FIGS. 7 and 8, an image IMG may include a plurality of pixels, each having a pixel value. A plurality of pixel values may be included in the image data IMGDATA, and each pixel value of the image data IMGDATA may be sequentially provided to the encryption device 720. The range of a pixel value in decimal is 0 to 255, a pixel value may be represented in binary, and the number of binary random numbers required to correspond to the pixel value in decimal is 8. The random number generation device 710 according to the disclosure may generate a quaternary random number, a hexadecimal random number, or a base-256 random number. In this case, for example, the pixel values of nine pixels PX included in the image IMG may be 82, 108, 179, 56, 125, 191, 90, 180, and 196 in decimal, respectively. When the random number generation device 710 generates a quaternary random number, the pixel values of the nine pixels PX may be 1102, 1230, 2303, 0320, 1331, 2333, 1122, 2310, and 3010 in quaternary, respectively. As described above, for pixel values corresponding to all gray scales, random numbers may be represented by only four-digit random number columns.

The key data KEYDATA corresponding to a security key SKEY may include random numbers used to encrypt the image IMG. The number of random numbers constituting the security key SKEY may be, for example, a value obtained by the number of pixels included in the image IMG by the number of digits for indicating one pixel value in quaternary. However, the disclosure is not limited thereto. Four random numbers for one pixel value may be sequentially provided to the encryption device 720 as one unit.

The encryption device 720 may perform an encryption operation 800 by using the image IMG and the security key SKEY. In some embodiments, the encryption device 720 may include an exclusive OR (XOR) operator configured to perform an XOR operation for encryption in a one-pixel unit (e.g., perform an XOR operation for each pixel). For example, the encryption device 720 may perform an XOR operation on values placed in the same columns of 1102 in quaternary of the image data IMGDATA and four random numbers of the key data KEYDATA. When the encryption operation 800 is completed, an encrypted image ECRTIMG converted into the form of noise image may be generated. Thereafter, the image IMG may be restored when a decryption operation on the security key SKEY and the encrypted image ECRTIMG is performed.

In the image processing field, the crypto system 700 according to the disclosure may use a sequence in quaternary or above to represent both an original image and a key. Accordingly, compared to when pixel information is encoded to an eight-bit binary sequence, the amount of data processing and the amount of power consumption of image processing may be reduced by 50% or more, and the data processing speed and security level may be improved.

While the disclosure has been particularly shown and described with reference to embodiments thereof, it will be understood that various changes in form and details may be made therein without departing from the spirit and scope of the following claims.

While this disclosure contains many specific implementation details, these should not be construed as limitations on the scope of what may be claimed, equivalents thereof, as well as claims to be described later. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

What is claimed is:

1. A random number generation device comprising at least one true random number generator,
the at least one true random number generator comprising:
a gated diode including
a first region,
a second region,
an intrinsic region between the first region and the second region,
a first gate region on the intrinsic region and doped with a first dopant, a first gate electrode on the first gate region,
a second gate region on the intrinsic region, wherein the second gate region is arranged side by side with the first gate region and is doped with a second dopant having characteristics different from characteristics of the first dopant, and
a second gate electrode on the second gate region; and
a resistor electrically connected in series to the gated diode.

2. The random number generation device of claim 1, wherein the gated diode comprises an anode electrode on the first region and a cathode electrode on the second region, and the resistor is electrically connected to the cathode electrode.

3. The random number generation device of claim 2, comprising:
a pulse generator configured to apply, during an on period, a pulse signal to the anode electrode, wherein the pulse signal comprises a voltage level during the on period;
a voltage source circuit configured to apply a first gate voltage to the first gate electrode, and to apply a second gate voltage to the second gate electrode, wherein the second gate voltage is different from the first gate voltage.

4. The random number generation device of claim 3, wherein the gated diode is configured to output a current according to a probability based on the voltage level of the pulse signal, a voltage level of the first gate voltage, and a voltage level of the second gate voltage.

5. The random number generation device of claim 1, wherein the first gate region is closer to the first region than to the second region, the second gate region is closer to the second region than to the first region, the first dopant is an n-type dopant, the second dopant is a p-type dopant, a positive voltage is applied to the first gate electrode, and a negative voltage is applied to the second gate electrode.

6. The random number generation device of claim 1, wherein the first gate region is closer to the second region than to the first region, the second gate region is closer to the first region than to the second region, the first dopant is a p-type dopant, the second dopant is an n-type dopant, a negative voltage is applied to the first gate electrode, and a positive voltage is applied to the second gate electrode.

7. The random number generation device of claim 1, wherein the gated diode comprises a gate insulating region on the intrinsic region and under the first and second gate regions.

8. A random number generation device comprising:
a pulse generator configured to generate a pulse signal having a voltage level during an on period;
a voltage source circuit configured to provide gate voltages; and
at least one true random number generator configured to generate a random number based on the pulse signal and the gate voltages,
wherein the at least one true random number generator comprises
a gated diode including an anode electrode configured to receive the pulse signal, a first gate electrode configured to receive a first gate voltage of the gate voltages, a second gate electrode configured to receive a second gate voltage of the gate voltages, and a cathode electrode, and
a resistor including a first terminal electrically connected to the cathode electrode and a second terminal electrically connected to an output node configured to output an output current having a current value corresponding to the random number.

9. The random number generation device of claim 8, wherein the at least one true random number generator comprises true random number generators electrically connected in parallel between the anode electrode and the output node, and each true random number generator is configured to output a respective current based on the voltage level of the pulse signal during the on period, and the output current of the at least one true random number generator corresponds to a sum of currents output from the true random number generators.

10. The random number generation device of claim 9, wherein the true random number generators comprise:
a first true random number generator configured to receive the pulse signal, a first gate voltage of the gate voltages, and a second gate voltage of the gate voltages, and to output a first current based on the pulse signal;
a second true random number generator configured to receive the pulse signal, a third gate voltage of the gate voltages, and a fourth gate voltage of the gate voltages, and to output a second current based on the pulse signal; and
a third true random number generator configured to receive the pulse signal, a fifth voltage of the gate voltages, and a sixth gate voltage of the gate voltages, and to output a third current based on the pulse signal.

11. The random number generation device of claim 8, wherein the random number is a base-n random number, n is an integer greater than or equal to 2, and a number of true random number generators is n-1.

12. The random number generation device of claim 8, comprising a post processor configured to output a second data stream including second random numbers based on a first data stream including first random numbers output from the at least one true random number generator.

13. The random number generation device of claim 12, wherein the post processor is configured to add random numbers in same random number columns of two random sequences in the first data stream, perform a modulo operation of calculating a remainder obtained by dividing the addition result by a base of the random number, and output a random sequence including values of the modulo operation.

14. A crypto system comprising:
a random number generation device configured to generate key data including random numbers constituting a security key; and
an encryption device configured to generate encrypted image data, based on the key data and image data including pixel values constituting an image,
wherein the random number generation device comprises
a pulse generator configured to generate a pulse signal having a voltage level during an on period,
a voltage source circuit configured to provide gate voltages, and
true random number generators configured to output an output current having a current value corresponding to a multinary random number for the pulse signal based on the pulse signal and the gate voltages.

15. The crypto system of claim 14, wherein the true random number generators are electrically connected in parallel to each other, and
each true random number generator of the true random number generators comprises:
a gated diode including an anode electrode configured to receive the pulse signal, a first gate electrode configured to receive a first gate voltage of the gate voltages , a second gate electrode configured to receive a second gate voltage of the gate voltages, and a cathode electrode; and
a resistor including a first terminal electrically connected in series to the cathode electrode and a second terminal electrically connected to an output node configured to output the output current.

16. The crypto system of claim 14, wherein the true random number generators comprise:
a first true random number generator configured to receive the pulse signal, a first gate voltage of the gate voltages, and a second gate voltage of the gate voltages, and to output a first current based on the pulse signal;
a second true random number generator configured to receive the pulse signal, a third gate voltage of the gate voltages, and a fourth gate voltage of the gate voltages, and to output a second current based on the pulse signal; and
a third true random number generator configured to receive the pulse signal, a fifth gate voltage of the gate voltages, and a sixth gate voltage of the gate voltages, and to output a third current based on the pulse signal.

17. The crypto system of claim 16, wherein the first gate voltage, the third gate voltage, and the fifth gate voltage each have a first polarity, and the second gate voltage, the fourth gate voltage, and the sixth gate voltage each have a second polarity that is different from the first polarity.

18. The crypto system of claim 14, wherein the random number generation device comprises a post processor configured to output a second data stream including second random numbers based on a first data stream including first random numbers output from the true random number generators.

19. The crypto system of claim 18, wherein the post processor is configured to add random numbers in same random number columns of two random sequences in the first data stream, perform a modulo operation of calculating a remainder obtained by dividing the addition result by a base of the random number, and output a random sequence including values of the modulo operation.

20. The crypto system of claim 14, wherein the encryption device is configured to generate the image data by performing an exclusive OR operation on a pixel value of each pixel in the image data and at least one multinary random number in the key data corresponding to the pixel value of each pixel .
